(19) United States
(12) Patent Application Publication
(10) Pub. No.: US 2005/0071798 A1
(43) Pub. Date: Mar. 31, 2005

(54) Power supply layout for an integrated circuit

(75) Inventors: Ching-Yao Chung, Daliao Township (TW); Nai-Yin Sung, Hsinchu City (TW); Yen-Hao Chen, Taichung City (TW)

Correspondence Address: John S. Egbert;Harrison & Egbert, 7th Floor, 412 Main Street, Houston, TX, 77002, US

(73) Assignee: GOYATEK TECHNOLOGY INC., Hsin-Chu (TW)

(21) Appl. No.: 10/721,198

(22) Filed: Nov. 25, 2003

(30) Foreign Application Priority Data
Sep. 10, 2003 (TW) 092125014

(51) Int. Cl. G06F 17/50

(52) U.S. Cl. 716/13

(57) ABSTRACT

A power supply layout for an integrated circuit has a plurality of power pads, a plurality of ground pads, a plurality of first-type conductive wires directly connected to the power pad, a plurality of second-type conductive wires directly connected to the ground pad, and a core circuit electrically connected to the first-type and the second-type conductive wires for acquiring the operational power. The integrated circuit is made of a plurality of metal layers, wherein the first-type conductive wire and the second-type conductive wire are positioned at different metal layers. The power pad is positioned at the same metal layer as the first-type conductive wire, while the ground pad is positioned at the same metal layer as the second-type conductive wire.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a power supply layout for an integrated circuit, and more particularly, to a power supply layout for an integrated circuit with a smaller die size.

### BACKGROUND OF THE INVENTION

In order to provide more functions, the number of electronic components in a single chip has been increasing continuously, which requires the size of the electronic components and the interconnections to shrink. As the size of the interconnections shrink, the time delay originating from the capacitance and the resistance of the interconnections will increase, which is an obstacle for high performance circuits. The resistance of the interconnection and the current passing therethrough results in a voltage drop that decreases the real voltage supplied to a core circuit. In addition, because the prevalence of single chip system, an integrated circuit usually comprises a plurality of the intellectual property (IP) element, which also increases the length and the resistance of the interconnection. As a result, the voltage drop will increase.

FIG. 1 is a schematic diagram of an integrated circuit 10 according to the prior art. As shown in FIG. 1, the integrated circuit 10 comprises a core circuit 12, a power ring 14 and a ground ring 24. Power pads 16 supply a positive potential (V_{DD}) to the power ring 14 through a metal wire 18, while ground pads 26 supply a negative potential (V_{SS}) to the ground ring 24 through a metal wire 28. The core circuit 12 acquires the positive potential and the negative potential directly from the power ring 14 and the ground ring 24 through the interconnection, such as a contact plug. The integrated circuit 10 uses the power ring technology to shorten the length of the interconnection between the power supply and the core circuit 12, thus the voltage drop can be decreased. Generally speaking, the integrated circuit 10 comprises a plurality of metal layers. If the electronic components of the core circuit 12 and the power ring 14 (or ground ring 24) are positioned at different metal layers, a via plug or a contact plug must be used for the electrical connection.

The prior art technology uses the power ring 14 and possesses the following disadvantages:
1. The chip area occupied by the power ring 14 and the ground ring 24 can not be used for other electronic components anymore. As the integration of the integrated circuit 10 increases and the size of electronic components shrink continuously, the power ring 14 and ground ring 24 occupy a relatively larger chip area.
2. Since the distances (the length of the interconnection) between the electronic components and the power ring 14 (or ground ring 24) are different, the voltage drops of the electronic components are different from each other. Particularly, the electronic component at the center of the core circuit 12 has the largest voltage drop since the distance is the longest.
3. The metal wire 18 and 28 are used to provide the desired potential to the power ring 14 and ground ring 24, respectively. If the power ring 14 and power pad 16 (or the ground ring 24 and ground pad 26) are positioned at different metal layers, the metal wire 18 and 28 are via plugs with higher resistance. Obviously, the metal wire 18 and 28 also cause an extra voltage drop in addition to the interconnection of the core circuit 12.
4. When designing the integrated circuit 10, the power consumption and electron migration (EM) effect of the core circuit 12 must be taken into consideration at first, then the widths of the power ring 14 and the ground ring 24 can be decided. The use of the power ring 14 and the ground ring 24 make the design of the integrated circuit 10 more complicated.

### BRIEF SUMMARY OF THE INVENTION

The objective of the present invention is to provide a power supply layout for an integrated circuit, which occupies a smaller die size.

In order to achieve the above-mentioned objective, and avoid the problems of the prior art, the present invention provides a power supply layout for an integrated circuit. The power supply layout for an integrated circuit comprises a plurality of power pads, a plurality of ground pads, a plurality of first-type conductive wires directly connected to the power pad, a plurality of second-type conductive wires directly connected to the ground pad and a core circuit electrically connected to the conductive wires for acquiring the operational power. The integrated circuit is made of a plurality of metal layers, wherein the first-type conductive wire and the second-type conductive wire are positioned at different metal layers. The power pad is positioned at the same metal layer as the first-type conductive wire, while the ground pad is positioned at the same metal layer as the second-type conductive wire.

The plurality of first-type conductive wires comprise a plurality of first wires and a plurality of second wires, wherein the first wire and the second wire are arranged in a mesh manner. If a certain region of the core circuit requires a higher power supply, the first-type conductive wire and the second-type conductive wire can be positioned with different pitches to provide more power to the region according to the present invention. Furthermore, the power supply layout comprises at least one auxiliary wire electrically connected to the first wire, and both ends of the auxiliary wire are not connected to the power pad. Using the auxiliary wire, more power connection points can be provided to decrease the voltage drop without increasing the number of the power pad.

Compared with the prior art technology, the present invention possesses the following advantages:
1. The power supply layout of the present invention does not use the power ring or ground ring, therefore the chip area occupied by the power ring and the ground ring can be saved.
2. The voltage drop of the electronic component of the core circuit can be maintained within an allowable range by arranging the conductive wire with different pitches and using the auxiliary wire.
3. The power pads and the first-type conductive wire directly connected the power pad can be positioned at the same metal layer, therefore the present invention can eliminate the voltage drop originating from the via plug used for electrical connecting the power ring and power pad.
4. Since the present invention does not use the power ring, it is no longer necessary to consider the power consumption and electron migration effect during the design of the power suppler layout. Therefore, the design work of the integrated circuit can be simplified.

### BRIEF DESCRIPTION OF THE SEVERAL VIEWS OF THE DRAWINGS

Other objectives and advantages of the present invention will become apparent upon reading the following description and upon reference to the accompanying drawings in which:

FIG. 1 is a schematic diagram of an integrated circuit according to the prior art;

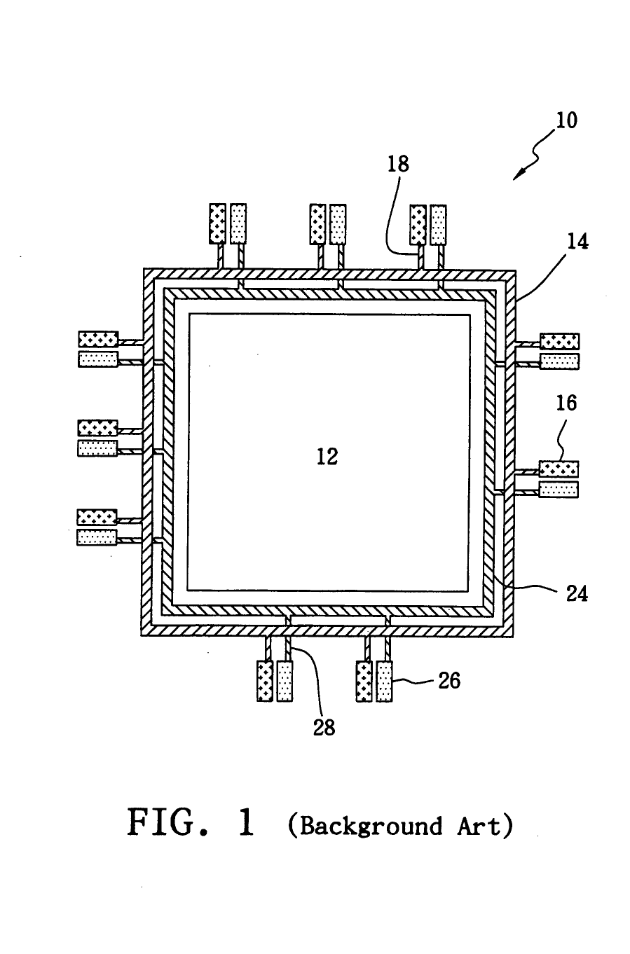

FIG. 2 is a schematic diagram of an integrated circuit according to the first embodiment of the present invention;

FIG. 3 is a schematic diagram of an integrated circuit according to the second embodiment of the present invention; and

FIG. 4 is a schematic diagram of an integrated circuit according to the third embodiment of the present invention.

### DETAILED DESCRIPTION OF THE INVENTION

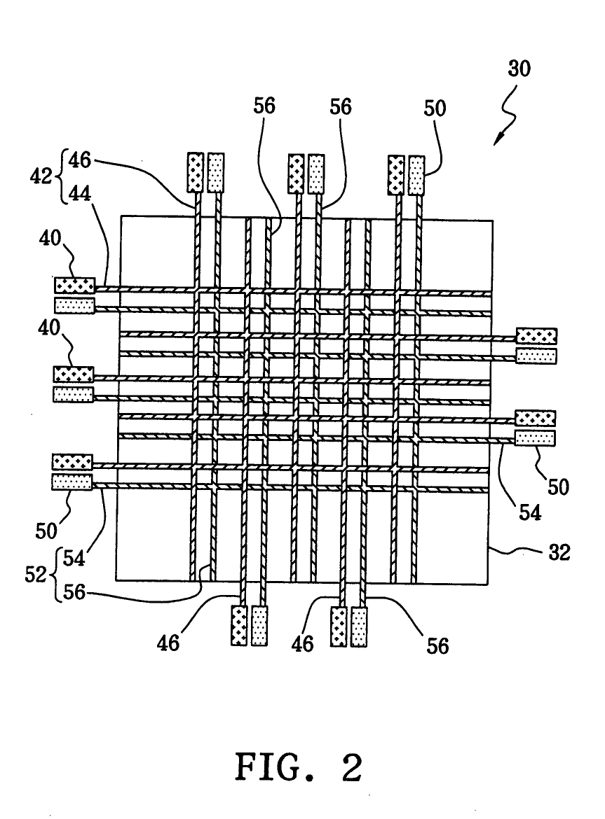

FIG. 2 is a schematic diagram of an integrated circuit 30 according to the first embodiment of the present invention. As shown in FIG. 2, the integrated circuit 30 comprises a plurality of power pads 40, a plurality of ground pads 50, a plurality of first-type conductive wires 42 directly connected to the power pad 40, a plurality of second-type conductive wires 52 directly connected to the ground pad 50, and a core circuit 32. The first-type conductive wire 42 is electrically connected to a positive potential, while the second-type conductive wires 52 is electrically connected to a ground potential. The integrated circuit 30 is made of a plurality of metal layers, and the first-type conductive wire 42 and the second-type conductive wire 52 are positioned at different metal layers. The power pad 40 and the first-type conductive wires 42 are positioned at the same metal layer, and the ground pads 50 and the second-type conductive wire 52 are positioned at the same metal layer.

The electronic components of the core circuit 32 are electrically connected to the first-type conductive wire 42 and the second-type conductive wire 52 for acquiring the operational power. The plurality of first-type conductive wire 42 and the plurality of second-type conductive wires 52 are arranged with an equivalent pitch between them, respectively. In addition, the first-type conductive wire 42 and the second-type conductive wire 52 are straight in shape, and one end of the conductive wire is electrically connected to the power pad 40 or the ground pad 50, respectively, i.e., the power pad 40 and the ground pad 50 are positioned around the core circuit 32 in an asymmetric manner.

The plurality of first-type conductive wires 42 comprises a plurality of first wires 44 and a plurality of second wires 46, wherein the plurality of first wires 44 and the plurality of second wires 46 are arranged in a mesh manner and across the core circuit 32. The electronic components of the core circuit 32 can be electrically connected to the first wire 44 and the second wire 46 through a contact plug (not shown in FIG. 2) to acquire the positive potential, and the contact plug is electrically connected to the nearest first-type conductive wire 42 to reduce the voltage drop. Similarly, the plurality of second-type conductive wires 52 also comprises a plurality of third wires 54 and a plurality of fourth wires 56 arranged in a mesh manner, and the electronic components of the core circuit 32 can be electrically connected to the third wire 54 and fourth wire 56 through a contact plug to obtain the ground potential.

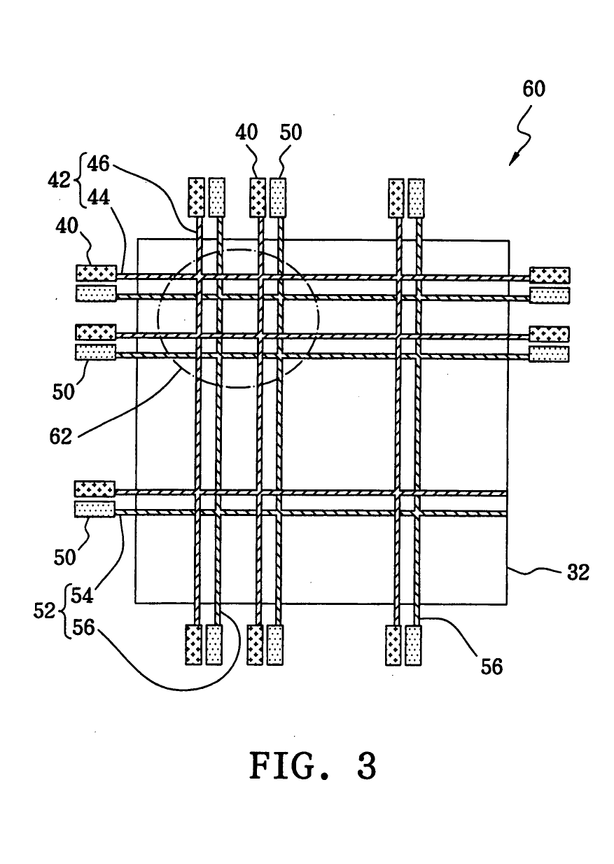

FIG. 3 is a schematic diagram of an integrated circuit 60 according to the second embodiment of the present invention. Compared with the integrated circuit 30 in FIG. 2, the first-type conductive wire 42 and the power pad 40 of the integrated circuit 60 are positioned with different pitches between them, and both ends of first-type conductive wire 42 are electrically connected to the power pads 40 positioned around the core circuit 32 directly. Similarly, the second-type conductive wires 52 and the ground pads 50 are positioned with different pitches between them, and both ends of the second-type conductive wires 52 are electrically connected to the ground pads 50 directly.

If a certain region 62 of the core circuit 32 requires a higher power supply, the designer can arrange the power pads 40 and ground pads 50 more densely around the region 62 than the other regions, i.e., arrange the first-type conductive wires 42 and second-type conductive wires 52 more densely around the region 62. The voltage drop of the integrated circuit 60 can be decreased to be lower than that of the integrated circuit 30 in FIG. 2 by arranging the conductive wires with different pitches and connecting both ends of the conductive wires to the power pad 40 (or the ground pad 50).

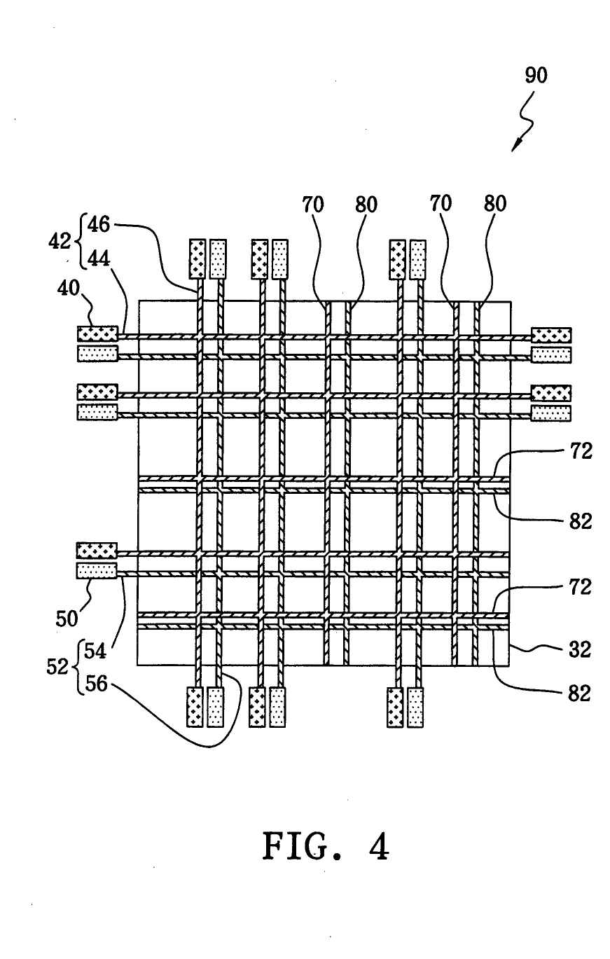

FIG. 4 is a schematic diagram of an integrated circuit 90 according to the third embodiment of the present invention. Compared with the integrated circuit 30 in FIG. 2, the integrated circuit 90 further comprises a plurality of first-type auxiliary wires 70, 72 and a plurality of second-type auxiliary wires 80,82. The first-type auxiliary wire 70 is positioned in parallel to the second wire 46, and the first-type auxiliary wire 72 is positioned in parallel to the first conductive wire 44. Neither of the ends of the first-type auxiliary wires 70,72 is connected to the power pad 40, but the first-type auxiliary wires 70,72 are electrically connected to the first wire 44 and the second wire 46, respectively, to maintain the positive potential. Similarly, neither of the ends of the second-type auxiliary wires 80, 82 is connected to the ground pad 50, but the second-type auxiliary wires 80,82 are electrically connected to the third wire 54 and the fourth wire 56, respectively, to maintain the ground potential. The first-type auxiliary wires 70, 72 and the second-type auxiliary wires 80,82 cooperate with the first-type conductive wire 42 and the second-type conductive wire 52 to form a more dense mesh, therefore the electronic components of the core circuit 32 can be electrically connected to the positive or negative potential by a shorter interconnection. As a result, the voltage drop can be decreased.

Since the present invention does not use the power ring, the chip area occupied by the power ring in prior art can be saved. The chip area occupied by the power ring can be calculated by the following formula:
PAR=1−x×y/[(x+4×+2×(s1+s2+s3))×(y+4×w+2×(s1+s2+s3))]
x: The width of the gate electrode
y: The height of the gate electrode
w: The width of the power ring or the ground ring
s1: The space between the inner ring and the gate electrode
s2: The space between the inner ring and the outer ring
s3: The space between the outer ring and the power pad

For example, the width and height of a gate electrode for a 0.13 um fabrication process are 900 um, the required width of the power ring is 20 um, and the space is 3 um. The chip area occupation ratio of the power ring calculated by the above formula is 18.675%, i.e., the present power supply layout can save 18.675% of the chip area.

Compared with the prior art technology, the present invention possesses the following advantages:
1. The power supply layout of the present invention does not use the power ring or ground ring, therefore the chip area occupied by the power ring and the ground ring can be saved.
2. The voltage drop of the electronic components of the core circuit can be maintained within an allowable range by arranging the conductive wire with different pitches and using the auxiliary wire.
3. The power pads and the first-type conductive wire directly connected the power pad can be positioned at the same metal layer, therefore the present invention can eliminate the voltage drop originating from the via plug used for electrical connecting the power ring and power pad.
4. Since the present invention does not use the power ring, it is no longer necessary to consider the power consumption and electron migration effect during the design of the power suppler layout. Therefore, the design work of integrated circuit can be simplified.

The above-described embodiments of the present invention are intended to be illustrative only. Numerous alternative embodiments may be devised by those skilled in the art without departing from the scope of the following claims.

1. A power supply layout for an integrated circuit, comprising:
a plurality of power pads;
a plurality of ground pads;
a plurality of conductive wires directly connected to the power pads or the ground pads; and
a core circuit electrically connected to the conductive wire to acquire power;
wherein the integrated circuit is comprised of a plurality of metal layers, the power pads and the conductive wires connected to the power pads are positioned at the same metal layer, and the ground pads and the conductive wires connected to the ground pads are positioned at the same metal layer.

2. The power supply layout for an integrated circuit of claim 1, wherein the plurality of conductive wires comprises:
a plurality of first wires; and
a plurality of second wires arranged with the plurality of first wires in a mesh manner.

3. The power supply layout for an integrated circuit of claim 2, further comprising at least one auxiliary wire electrically connected to the first wires, wherein both ends of the at least one auxiliary wire are not connected to the power pad or the ground pad.

4. The power supply layout for an integrated circuit of claim 1, wherein the plurality of conductive wires are straight in shape and one end of the conductive wire is electrically connected to the power pad or the ground pad directly.

5. The power supply layout for an integrated circuit of claim 1, wherein the plurality of conductive wires are straight in shape and both ends of the conductive wire are electrically connected to the power pad or the ground pad around the core circuit directly.

6. The power supply layout for an integrated circuit of claim 1, wherein the power pads and the ground pads are positioned around the core circuit in a different pitch manner.

7. A power supply layout for an integrated circuit, comprising:
a plurality of power pads;
a plurality of ground pads;
a plurality of first-type conductive wires directly connected to the plurality of power pads;
a plurality of second-type conductive wires directly connected to the plurality of ground pads; and
a core circuit electrically connected to the first-type conductive wires and the second conductive wires for acquiring power;
wherein the integrated circuit is comprised of a plurality of metal layers, and the first-type conductive wires and the second-type conductive wires are positioned at different metal layers.

8. The power supply layout for an integrated circuit of claim 7, wherein the plurality of first-type conductive wires comprises:
a plurality of first wires; and
a plurality of second wires arranged with the plurality of first wires in a mesh manner.

9. The power supply layout for an integrated circuit of claim 8, further comprising at least one auxiliary wire electrically connected to the first wire, wherein both ends of the at least one auxiliary wire are not connected to the power pad or the ground pad.

10. The power supply layout for an integrated circuit of claim 7, wherein the plurality of first-type conductive wires are straight in shape and one end of the first-type conductive wire is electrically connected to the power pad directly.

11. The power supply layout for an integrated circuit of claim 7, wherein the plurality of first-type conductive wires are straight in shape and both ends of the first-type conductive wire are electrically connected to the power pad around the core circuit directly.

12. The power supply layout for an integrated circuit of claim 7, wherein the power pad and the first-type conductive wire are electrically connected to a positive potential, while the ground pad and the second-type conductive wire are electrically connected to a ground potential.

13. The power supply layout for an integrated circuit of claim 7, wherein the power pads are positioned around the core circuit with different pitches.
